(19) United States
(12) Patent Application Publication
(10) Pub. No.: US 2012/0130715 A1
(43) Pub. Date: May 24, 2012

(54) METHOD AND APPARATUS FOR GENERATING A VOICE-TAG

(75) Inventors: Rui Zhao, Beijing (CN); Lei He, Beijing (CN)

(73) Assignee: Kabushiki Kaisha Toshiba

(21) Appl. No.: 13/241,518

(22) Filed: Sep. 23, 2011

(30) Foreign Application Priority Data
Nov. 24, 2010 (CN) 201010561793.6

(51) Int. Cl. G10L 15/06

(52) U.S. Cl. 704/243; 704/E15.007

(57) ABSTRACT

According to one embodiment, an apparatus for generating a voice-tag includes an input unit, a recognition unit, and a combination unit. The input unit is configured to input a registration speech. The recognition unit is configured to recognize the registration speech to obtain N-best recognition results, wherein N is an integer greater than or equal to 2. The combination unit is configured to combine the N-best recognition results as a voice-tag of the registration speech.

### CROSS-REFERENCE TO RELATED APPLICATIONS

This application is based upon and claims the benefit of priority from prior Chinese Patent Application No. 201010561793.6, filed Nov. 24, 2010, the entire contents of which are incorporated herein by reference.

### FIELD

Embodiments described herein relate generally to information processing technology.

### BACKGROUND

A voice-tag is a widely used speech recognition application, especially in embedded platforms. In voice-tag, firstly, a registration speech is inputted into a system and converted by the system into a voice-tag representing the registration speech. Then, a voice tag item is added to the recognition network. This process is called as registration. After this, a testing speech is recognized based on the recognition network including voice-tag items to determine its pronunciation. This process is called as recognition. Usually, the recognition network consists of not only the voice tag items but also other items whose pronunciations are decided by a dictionary or a G2P module, which can be called dictionary items.

The original voice-tag method is usually based on template matching framework. During registration, one or more templates are extracted as the tag of the registration speech. During recognition, the template matching method based on DTW algorithm is applied between a testing speech and template tags. Recently, along with the wide use of phoneme HMM based speech recognition technique, a phoneme sequence is more used as a voice-tag of a registration speech in current mainstream voice-tag systems. In a phoneme based voice-tag, a phoneme decoder is used to recognize the registration speech, and the phoneme sequence is output as the voice-tag. Such phoneme sequence based tags are cheap to stored, and easily combined with dictionary items, which is very helpful to enlarge the item number of a voice-tag system. But phoneme based voice-tag system also has shortages: due to the limitation of phoneme decoder, recognition errors during registration are unavoidable. On the other hand, the mismatch between registration and testing is another difficulty for a voice-tag. So, how to reduce the negative effects from registration errors and mismatch between registration and testing is a key issue for a voice-tag system.

In order to overcome the above negative effects of the phoneme sequence based tags, researchers use multi-entry pronunciations to represent one voice-tag item.

However, using multi-entry pronunciations for one item will increase the total confusion of the recognition network, and especially drop the recognition performance for dictionary items.

### BRIEF DESCRIPTION OF THE DRAWINGS

FIG. 1 is a flowchart showing a method for generating a voice-tag according to a first embodiment.

FIG. 2 is a diagram showing an example for combining two best recognition results into one sequence in HMM state level according to the first embodiment.

FIG. 3 is a block diagram showing an apparatus for generating a voice-tag according to a second embodiment.

FIG. 4 is a block diagram showing a specific configuration of a combination unit of the apparatus for generating a voice-tag according to the second embodiment.

### DETAILED DESCRIPTION

In general, according to one embodiment, an apparatus for generating a voice-tag includes an input unit, a recognition unit, and a combination unit. The input unit is configured to input a registration speech. The recognition unit is configured to recognize the registration speech to obtain N-best recognition results, wherein N is an integer greater than or equal to 2. The combination unit is configured to combine the N-best recognition results as a voice-tag of the registration speech.

Next, a detailed description of the embodiments will be given in conjunction with the drawings.

Method for Generating a Voice-Tag

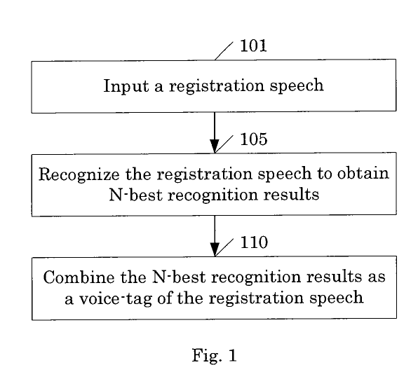

FIG. 1 is a flowchart showing a method for generating a voice-tag according to the first embodiment.

As shown in FIG. 1, first, in step 101, a registration speech is inputted. In the embodiment, the inputted registration speech can be any type of speech known by those skilled in the art, and the present invention has no limitation on this.

Next, in step 105, the registration speech inputted in step 101 is recognized, and N best recognition results are obtained, wherein N is an integer greater than or equal to 2. In the embodiment, the method for recognizing the registration speech can be any recognition method known by those skilled in the art, and the present invention has no limitation on this as long as recognition results representing pronunciations of the registration speech can be recognized from the registration speech.

In the embodiment, recognition results representing pronunciations of the registration speech can be pronunciation unit sequences or pronunciation unit lattices etc., wherein the pronunciation unit can be a phoneme, a syllable, a word a phrase or a combination thereof, or any other pronunciation unit known by those skilled in he art, and the present invention has no limitation on this as long as the pronunciation of the registration speech can be represented by them. Next, the phoneme sequence will be used as an example for describing.

Specifically, in step 105, the inputted registration speech is recognized with respect to phoneme to obtain a plurality of candidate phoneme sequences. N best phoneme sequences are selected in the plurality of candidate phoneme sequences as the recognition results of step 105. In the embodiment, the method for selecting N best phoneme sequences in the plurality of candidate phoneme sequences can be any method known by those skilled in the art, and the present invention has no limitation on this. For example, firstly, the score of each of the plurality of candidate phoneme sequences is calculated. Next, the plurality of candidate phoneme sequences are ranked from high score to low score. Finally, the first N phoneme sequences after ranking are used as the N best phoneme sequences.

In the embodiment, in step 105, the registration speech inputted in step 101 may be recognized based on a Hidden Markov model (HMM) to obtain the N-best phoneme sequences and corresponding HMM state level time segmentation information. The method for recognizing the registration speech based on HMM can be any method known by those skilled in the art, such as a specific method disclosed in non-patent reference 2 (“Fundamentals of speech recognition”, Rabiner R., Juang B. H., Englewood Cliffs, N.J., Prentice Hall, 1993, all of which are incorporated herein by reference), and the present invention has no limitation on this as long as the N-best phoneme sequences and corresponding HMM state level time segmentation information can be obtained.

Next, in step 110, the N-best recognition results recognized in step 105 are combined as the voice-tag of the registration speech inputted in step 101.

Specifically, in the case where the registration speech is recognized in step 105 based on HMM, in step 110, the N-best recognition results are combined as the voice-tag of the registration speech based on the corresponding HMM state level time segmentation information.

In the embodiment, in the combination process, firstly a union set among state level time segmentation points of the N-best recognition results may be determined as new time segmentation points. Then, N states from the N-best recognition results, which are within a same time segmentation period, are combined as one state based on the new time segmentation points, wherein a combined state sequence is used as the voice-tag of the registration speech.

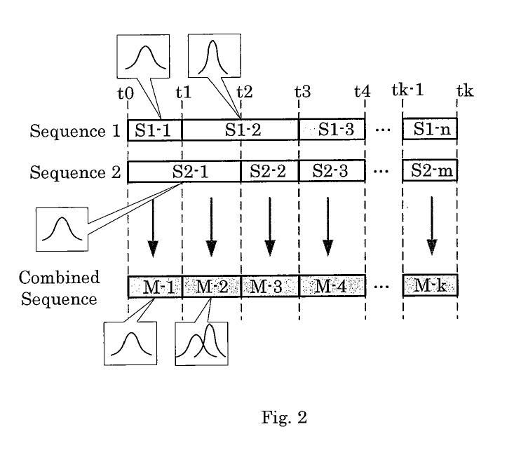

Next, the combination process will be described in detail with reference to FIG. 2. FIG. 2 is a diagram showing an example for combining two best recognition results into one sequence in HMM state level according to the first embodiment. In FIG. 2, N=2 is taken as an example for describing. That is to say, 2 best phoneme sequences are selected from the plurality of candidate recognition results recognized in step 105.

As shown in FIG. 2, phoneme sequence 1 includes n states of S1-1, S1-2, . . . , S1-n, and phoneme sequence 2 includes m states of S2-1, S2-2, . . . , S2-m, wherein phoneme 1 includes n+1 time segmentation points and phoneme sequence 2 includes m+1 time segmentation points.

In the combination process of the embodiment, firstly, a union of n+1 time segmentation points of phoneme sequence 1 and m+1 time segmentation points of phoneme sequence 2 is determined as the new time segmentation points. As shown in FIG. 2, the new time segmentation points are t0, t1, . . . , tk, that is k+1 points. For example, in the case where n and m are 3, phoneme sequence 1 includes 3 states of S1-1, S1-2 and S1-3 and 4 time segmentation points of t0, t1, t3 and t4, and phoneme sequence 2 includes 3 states of S2-1, S2-2 and S2-3 and 4 time segmentation points of t0, t2, t3 and t4. In this case, the union of time segmentation points of phoneme sequence 1 and time segmentation points of phoneme sequence 2 is {t0, t1, t2, t3, t4}.

Next, based on the new time segmentation points are t0, t1, . . . , tk, states within each time segmentation period of phoneme sequence 1 and phoneme sequence 2 are combined as one state. Specifically, state S1-1 and state S2-1 between t0 and t1 are combined as state M-1, state S1-2 and state S2-1 between t1 and t2 are combined as state M-2, state S1-2 and state S2-2 between t2 and t3 are combined as state M-3, state S1-3 and state S2-3 between t3 and t4 are combined as state M-4, . . . , state S1-n and state S2-m between tk-1 and tk are combined as state M-k. Therefore, a combined state sequence is obtained and used as the voice-tag of the registration speech.

In the method for generating a voice-tag, through combining multiple recognition results representing multi-entry pronunciations as a pronunciation sequence which is used as the voice-tag of the registration speech, the confusion of the recognition network including the voice-tags can be reduced, and the recognition performance of a voice-tag system, especially the recognition performance for dictionary items can be improved. Moreover, neither the computational cost nor the model size of the method of the present embodiment is increased obviously comparing with the traditional multi-entry representation method.

In the embodiment, output probability distribution of the state after combination may be a union of Gaussian components of the N states before combination. For example, as shown in FIG. 2, the output probability distribution of the state M-1 is a union of Gaussian components of the states of S1-1 and S2-1, and the output probability distribution of the state M-2 is a union of Gaussian components of the states of S1-2 and S2-1.

In the embodiment, a weight of each Gaussian component of the state after combination may be the sum of weights of Gaussian components before combination which are same with the each Gaussian component, divided by N. For example, as shown in FIG. 2, the combined state M-1 only has one Gaussian component, and Gaussian components before combination which are same with the one Gaussian component are Gaussian component of the state S1-1 (the weight of which is 1) and Gaussian component of the state S2-1 (the weight of which is 1). Therefore, the weight after combination is (1+1)/2, that is 1. The combined state M-2 has two Gaussian components, the left one is same with Gaussian component of the state S2-1 (the weight of which is 1) and the right one is same with Gaussian component of the state S1-2 (the weight of which is 1). After combination, the weight of the left one is the weight of Gaussian component of the state S2-1 divided by 2, that is ½, and the weight of the right one is the weight of Gaussian component of the state S1-2 divided by 2, that is ½.

Moreover, optionally, the weight of each Gaussian component of the state after combination can be calculated based on confidence score of states including Gaussian components before combination which are same with the each Gaussian component. The method for calculating the weight based on confidence score can be any method known by those skilled in the art, and the present invention has no limitation on this.

In the method for generating a voice-tag of the present embodiment, since the combined state sequence includes all Gaussian components from the multiple recognition results, it is supposed to model the variance of registration speech better, while brings less confusion into the recognition network.

Apparatus for Generating a Voice-Tag

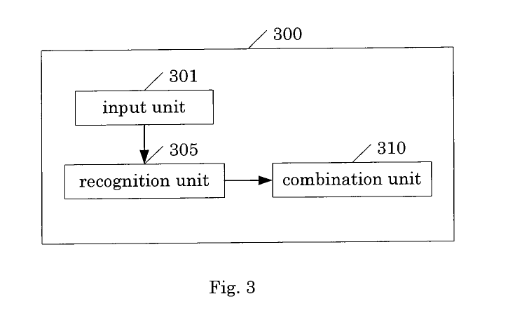

Based on the same concept of the invention, FIG. 3 is a block diagram showing an apparatus for generating a voice-tag according to the second embodiment. The description of this embodiment will be given below in conjunction with FIG. 3, with a proper omission of the same content as those in the above-mentioned embodiments.

As shown in FIG. 3, the apparatus 300 for generating a voice-tag of the embodiment comprises: an input unit 301 configured to input a registration speech; a recognition unit 305 configured to recognize said registration speech to obtain N-best recognition results, wherein N is an integer greater than or equal to 2; and a combination unit 310 configured to combine said N-best recognition results as a voice-tag of said registration speech.

In the embodiment, the registration speech inputted by the input unit 301 can be any type of speech known by those skilled in the art, and the present invention has no limitation on this.

In the embodiment, the recognition unit 305 for recognizing the registration speech can be any recognition module known by those skilled in the art, and the present invention has no limitation on this as long as recognition results representing pronunciations of the registration speech can be recognized from the registration speech.

In the embodiment, recognition results representing pronunciations of the registration speech can be pronunciation unit sequences or pronunciation unit lattices etc., wherein the pronunciation unit can be a phoneme, a syllable, a word a phrase or a combination thereof, or any other pronunciation unit known by those skilled in he art, and the present invention has no limitation on this as long as the pronunciation of the registration speech can be represented by them. Next, the phoneme sequence will be used as an example for describing.

Specifically, the inputted registration speech is recognized by the recognition unit 305 with respect to phoneme to obtain a plurality of candidate phoneme sequences. N best phoneme sequences are selected in the plurality of candidate phoneme sequences as the recognition results of the recognition unit 305. In the embodiment, the method for selecting N best phoneme sequences in the plurality of candidate phoneme sequences can be any method known by those skilled in the art, and the present invention has no limitation on this. For example, firstly, the score of each of the plurality of candidate phoneme sequences is calculated. Next, the plurality of candidate phoneme sequences are ranked from high score to low score. Finally, the first N phoneme sequences after ranking are used as the N best phoneme sequences.

In the embodiment, the registration speech inputted by the input unit 301 may be recognized by the recognition unit 305 based on a Hidden Markov model (HMM) to obtain the N-best phoneme sequences and corresponding HMM state level time segmentation information. The method for recognizing the registration speech based on HMM can be any method known by those skilled in the art, such as a specific method disclosed in the above non-patent reference 2, and the present invention has no limitation on this as long as the N-best phoneme sequences and corresponding HMM state level time segmentation information can be obtained.

In the embodiment, in the case where the registration speech is recognized by the recognition unit 305 based on HMM, the N-best recognition results are combined by the combination unit 310 as the voice-tag of the registration speech based on the corresponding HMM state level time segmentation information.

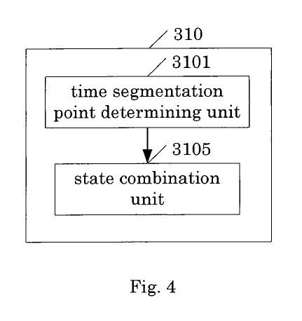

In the embodiment, as shown in FIG. 4, the combination unit 310 comprises: a time segmentation point determining unit 3101 configured to determine a union set among state level time segmentation points of said N-best recognition results as new time segmentation points; and a state combination unit 3105 configured to combine N states from said N-best recognition results, which are within a same time segmentation period, as one state based on said new time segmentation points, wherein a combined state sequence is used as said voice-tag of said registration speech.

Next, the combination process of the combination unit 310 as shown in FIG. 4 will be described in detail with reference to FIG. 2. In FIG. 2, N=2 is taken as an example for describing. That is to say, 2 best phoneme sequences are selected from the plurality of candidate recognition results recognized by the recognition unit 305.

As shown in FIG. 2, phoneme sequence 1 includes n states of S1-1, S1-2, . . . , S1-n, and phoneme sequence 2 includes m states of S2-1, S2-2, . . . , S2-m, wherein phoneme 1 includes n+1 time segmentation points and phoneme sequence 2 includes m+1 time segmentation points.

In the combination process of the embodiment, firstly, a union of n+1 time segmentation points of phoneme sequence 1 and m+1 time segmentation points of phoneme sequence 2 is determined by the time segmentation point determining unit 3101 as the new time segmentation points. As shown in FIG. 2, the new time segmentation points are t0, t1, . . . , tk, that is k+1 points. For example, in the case where n and m are 3, phoneme sequence 1 includes 3 states of S1-1, S1-2 and S1-3 and 4 time segmentation points of t0, t1, t3 and t4, and phoneme sequence 2 includes 3 states of S2-1, S2-2 and S2-3 and 4 time segmentation points of t0, t2, t3 and t4. In this case, the union of time segmentation points of phoneme sequence 1 and time segmentation points of phoneme sequence 2 is {t0, t1, t2, t3, t4}.

Next, based on the new time segmentation points are t0, t1, . . . , tk, states within each time segmentation period of phoneme sequence 1 and phoneme sequence 2 are combined by the state combination unit 3105 as one state. Specifically, state S1-1 and state S2-1 between t0 and t1 are combined as state M-1, state S1-2 and state S2-1 between t1 and t2 are combined as state M-2, state S1-2 and state S2-2 between t2 and t3 are combined as state M-3, state S1-3 and state S2-3 between t3 and t4 are combined as state M-4, . . . , state S1-n and state S2-m between tk-1 and tk are combined as state M-k. Therefore, a combined state sequence is obtained and used as the voice-tag of the registration speech.

In the apparatus 300 for generating a voice-tag of the present embodiment, through combining multiple recognition results representing multi-entry pronunciations as a pronunciation sequence which is used as the voice-tag of the registration speech, the confusion of the recognition network including the voice-tags can be reduced, and the recognition performance of a voice-tag system, especially the recognition performance for dictionary items can be improved. Moreover, neither the computational cost nor the model size of the apparatus 300 is increased obviously comparing with the traditional multi-entry representation method.

In the embodiment, output probability distribution of the state combined by the combination unit 310 may be a union of Gaussian components of the N states before combination. For example, as shown in FIG. 2, the output probability distribution of the state M-1 is a union of Gaussian components of the states of S1-1 and S2-1, and the output probability distribution of the state M-2 is a union of Gaussian components of the states of S1-2 and S2-1.

In the embodiment, a weight of each Gaussian component of the state combined by the combination unit 310 may be the sum of weights of Gaussian components before combination which are same with the each Gaussian component, divided by N. For example, as shown in FIG. 2, the combined state M-1 only has one Gaussian component, and Gaussian components before combination which are same with the one Gaussian component are Gaussian component of the state S1-1 (the weight of which is 1) and Gaussian component of the state S2-1 (the weight of which is 1). Therefore, the weight after combination is (1+1)/2, that is 1. The combined state M-2 has two Gaussian components, the left one is same with Gaussian component of the state S2-1 (the weight of which is 1) and the right one is same with Gaussian component of the state S1-2 (the weight of which is 1). After combination, the weight of the left one is the weight of Gaussian component of the state S2-1 divided by 2, that is ½, and the weight of the right one is the weight of Gaussian component of the state S1-2 divided by 2, that is ½.

Moreover, optionally, the weight of each Gaussian component of the state combined by the combination unit 310 can be calculated based on confidence score of states including Gaussian components before combination which are same with the each Gaussian component. The method for calculating the weight based on confidence score can be any method known by those skilled in the art, and the present invention has no limitation on this.

In the apparatus 300 for generating a voice-tag of the present embodiment, since the combined state sequence includes all Gaussian components from the multiple recognition results, it is supposed to model the variance of registration speech better, while brings less confusion into the recognition network.

Though the method and apparatus for generating a voice-tag have been described in details with some exemplary embodiments, these above embodiments are not exhaustive.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for generating a voice-tag, comprising:
an input unit configured to input a registration speech;
a recognition unit configured to recognize said registration speech to obtain N-best recognition results, wherein N is an integer greater than or equal to 2; and
a combination unit configured to combine said N-best recognition results as a voice-tag of said registration speech.

2. The apparatus according to claim 1, wherein said recognition unit is configured to recognize said registration speech based on a Hidden Markov model (HMM) to obtain said N-best recognition results and corresponding HMM state level time segmentation information.

3. The apparatus according to claim 2, wherein said combination unit is configured to combine said N-best recognition results as said voice-tag of said registration speech based on said corresponding HMM state level time segmentation information.

4. The apparatus according to claim 3, wherein said combination unit further comprises:
a time segmentation point determining unit configured to determine a union set among state level time segmentation points of said N-best recognition results as new time segmentation points; and
a state combination unit configured to combine N states from said N-best recognition results, which are within a same time segmentation period, as one state based on said new time segmentation points, wherein a combined state sequence is used as said voice-tag of said registration speech.

5. The apparatus according to claim 4, wherein output probability distribution of said state after combination is a union of Gaussian components of said N states before combination.

6. The apparatus according to claim 5, wherein a weight of each Gaussian component of said state after combination is the sum of weights of Gaussian components before combination which are same with said each Gaussian component, divided by N.

7. The apparatus according to claim 5, wherein a weight of each Gaussian component of said state after combination is calculated based on confidence score of states including Gaussian components before combination which are same with said each Gaussian component.

8. The apparatus according to claim 1, wherein said N-best recognition results comprise N-best pronunciation unit sequences or pronunciation unit lattices.

9. The apparatus according to claim 8, wherein said pronunciation unit includes a phoneme, a syllable, a word and/or a phrase.

10. A method for generating a voice-tag, comprising:
inputting a registration speech;
recognizing said registration speech to obtain N-best recognition results, wherein N is an integer greater than or equal to 2; and
combining said N-best recognition results as a voice-tag of said registration speech.

11. The method according to claim 10, wherein said recognizing comprises recognizing said registration speech based on a Hidden Markov model (HMM) to obtain said N-best recognition results and corresponding HMM state level time segmentation information.

12. The method according to claim 11, wherein said combining comprises combining said N-best recognition results as said voice-tag of said registration speech based on said corresponding HMM state level time segmentation information.

13. The method according to claim 12, wherein said combining further comprises:
determining a union set among state level time segmentation points of said N-best recognition results as new time segmentation points; and
combining N states from said N-best recognition results, which are within a same time segmentation period, as one state based on said new time segmentation points, wherein a combined state sequence is used as said voice-tag of said registration speech.

14. The method according to claim 13, wherein output probability distribution of said state after combination is a union of Gaussian components of said N states before combination.

15. The method according to claim 14, wherein a weight of each Gaussian component of said state after combination is the sum of weights of Gaussian components before combination which are same with said each Gaussian component, divided by N.

16. The method according to claim 14, wherein a weight of each Gaussian component of said state after combination is calculated based on confidence score of states including Gaussian components before combination which are same with said each Gaussian component.

17. The method according to claim 10, wherein said N-best recognition results comprise N-best pronunciation unit sequences or pronunciation unit lattices.

18. The method according to claim 17, wherein said pronunciation unit includes a phoneme, a syllable, a word and/or a phrase.
